(19) United States
(12) Patent Application Publication
(10) Pub. No.: US 2016/0034911 A1
(43) Pub. Date: Feb. 4, 2016

(54) Expert System for Rating Credence Goods' Claims to Being Environmentally Friendly

(71) Applicant: William J. Keane, McLean, VA (US)

(72) Inventor: William J. Keane, McLean, VA (US)

(21) Appl. No.: 14/818,027

(22) Filed: Aug. 4, 2015

Related U.S. Application Data
(60) Provisional application No. 62/032,907, filed on Aug. 4, 2014.

(51) Int. Cl. G06Q 30/00

(52) U.S. Cl. CPC G06Q 30/018

(57) ABSTRACT

An expert system for evaluating the criteria of environmental labels on consumer products is presented. The system employs a special purpose computer for receiving information about environmental labels, obtaining the criteria used these environmental labels, and sending information to teams of experts who independently evaluate each criteria section against the ISO standards for environmental labels. The system then stores the criteria and the expert evaluations of the criteria and calculates an overall rating for a product based on its environmental labels. The experts work independently on different aspects of rating criteria before a final to assure a reliable final rating. Users may access information about an environmental label, for example, through a mobile device with a camera and interact access. The present invention allows consumers to purchase products based on an impartial rating and avoid being misled by unreliable environmental labels.

This application claims the benefit of priority to U.S. Provisional Patent Application Ser. No. 62/032,907 filed Aug. 4, 2014 by the same inventor and incorporates its entire contents by reference.

### BACKGROUND

People are becoming more concerned about the environmental impact of the products and services they purchase. As a result, sellers are using many Environmental Certificates (Eco Labels) that, in theory, are sustainability measurements of their products or services.

Since sellers have found that Eco Labels greatly increase sales, bogus labels are rampant. Anyone can setup an “Eco” Label and many labels are like junk bonds—worthless. Because each Eco Label issuer has their own criteria, consumers are left wondering which Ecolabel is valid. The Wall Street Journal states that 98% of consumer products use some type of deceptive eco claims. Other studies show that more than 95% of consumer products examined committed at least one offense of “greenwashing,” a term use to describe unproven environmental claims.

Because of these misleading claims some governments are cracking down. In the United States, the Federal Trade Commission (FTC) and in Europe the European Union are either enforcing existing consumer laws or proposing new legislation.

This growing issue has led to confusion and fatigue among consumers. To address the demand for standards, they have undertaken efforts to standardize the principles, practices and key characteristics relating to three major voluntary environmental labeling types—Type I—environmental labeling (i.e. EcoLables), Type II—self-declaration claims and Type III—environmental declarations (e.ge. report cards/information labels).

The rating groups have taken these ISO standards along with various other laws, regulations and best practices to develop the various criteria for a company's products or services that they must meet to receive one of their labels and/or certificates.

### SUMMARY OF THE INVENTION

To address this problem, the present invention will set up a Five Star Rating Process to rate Eco Labels and compare them with the criteria of the Internal Organization for Standardization (ISO) standards for environmental labeling. The criteria used in the present invention includes ISO 14020 Environmental Labels and Declarations—General Principles, ISO 14021 (Type II environmental labeling, self-declared environmental claims), ISO 14024 (Type I environmental labeling—environmental labels and declarations), and ISO 14025 (Type III environmental declarations i.e. “report cards” and information labels.) The result will allow shoppers to see where a particular label falls in a five star range.

### BRIEF DESCRIPTION OF THE DRAWINGS

FIG. 1 is a graphical overview of the data entry configuration of the present invention.

FIG. 2 is a flowchart showing how the present invention obtains criteria for an Eco Label on a product, compares it with the international standards, employs teams to evaluate and sort the criteria and provide quality control and expert review for Eco Label evaluation.

FIG. 3 is a flowchart depicting the algorithm for providing a final score for an Eco Label, and a summary of the entire rating process.

FIG. 4 is a graphical overview of the architectural components of a client-server database supporting indexing, search and retrieval according to one embodiment using multiple search engines.

FIG. 5 is a diagram showing an example of the computer system of a sophisticated mobile device, with camera, global positioning system and other components not shown.

### DETAILED DESCRIPTION

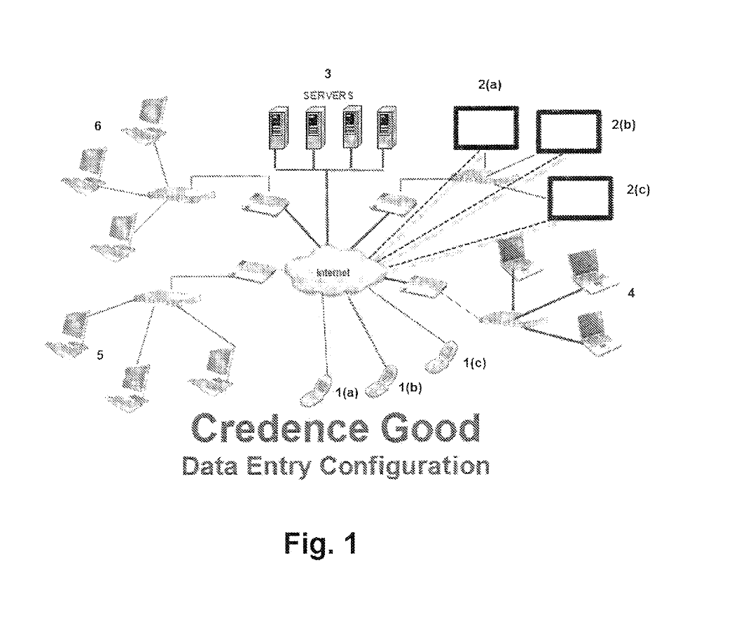

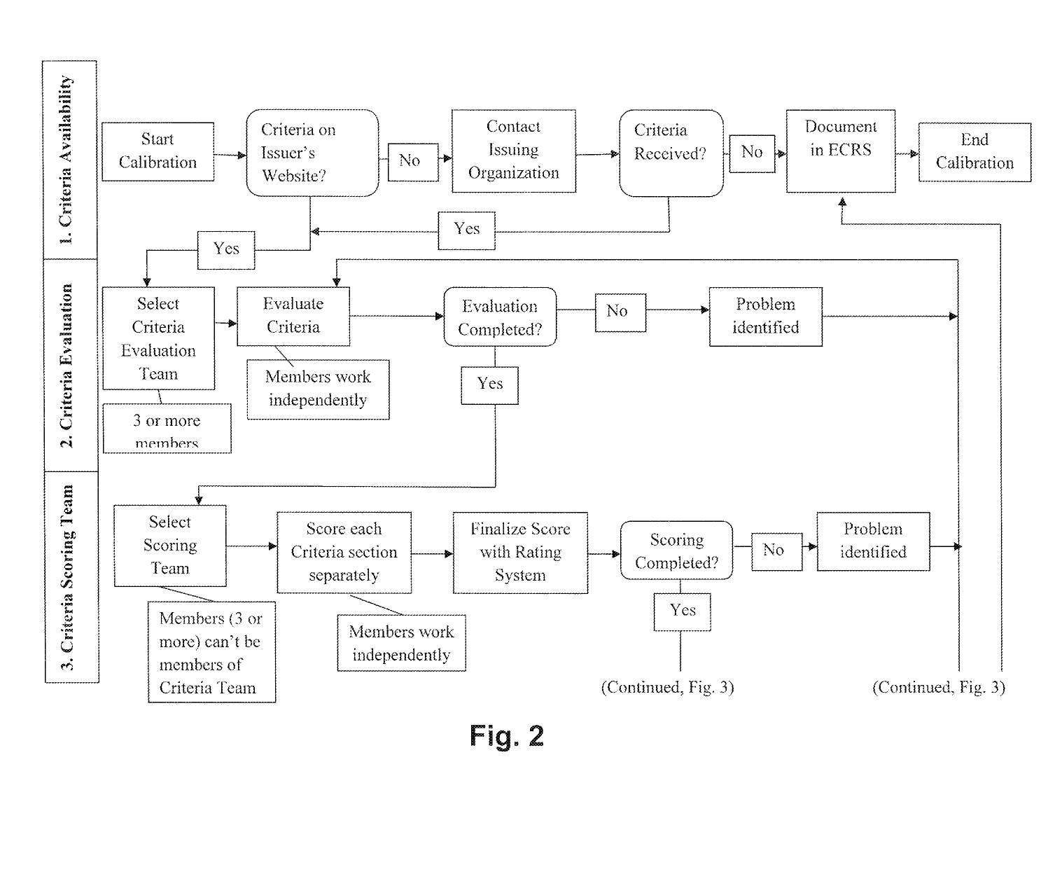

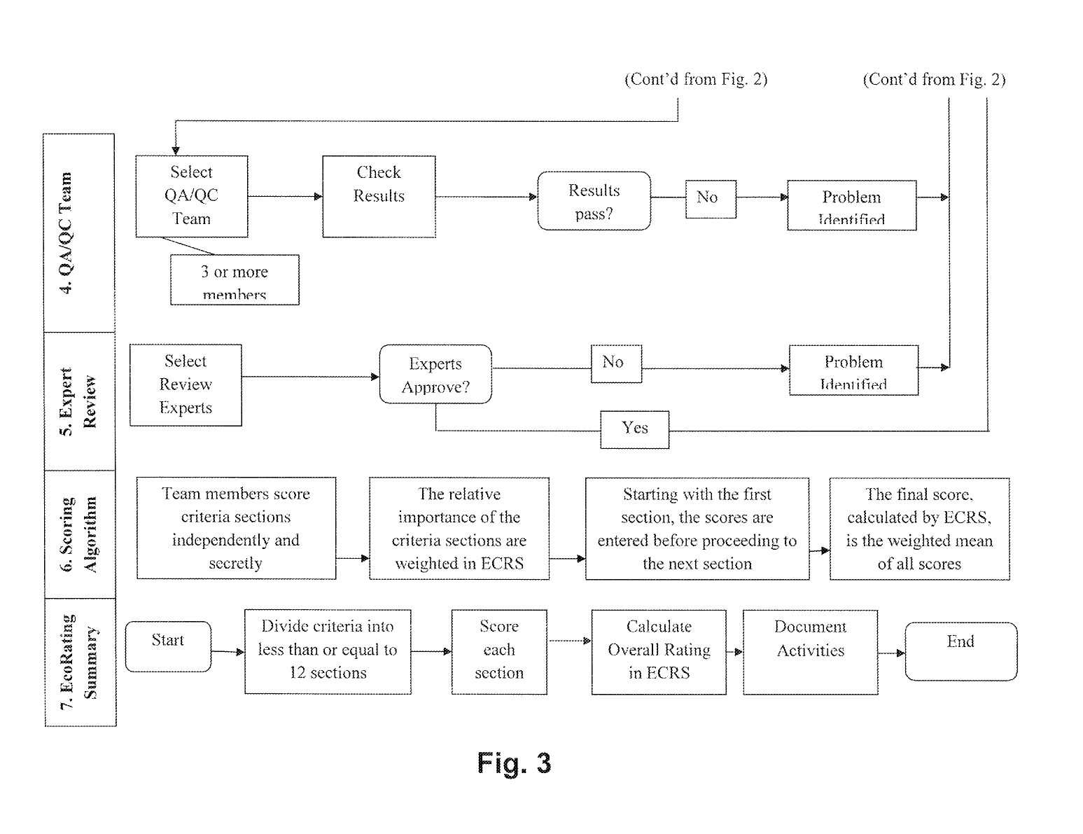

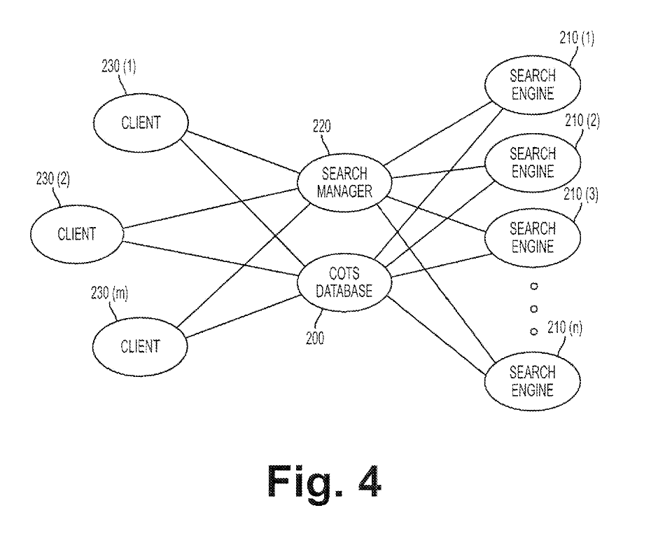

The Five Star rating process is the present invention's Expert System to convert all Eco Labels to single universal scale. FIG. 1 is a diagram depicting how Eco Label criteria rating data may be acquired and stored in the present invention's servers 3. In one embodiment, clients may use mobile devices 1(a), 1(b), 1(c) equipped with cameras to scan an environmental label and retrieve a rating of the product from the system's servers 3 if such information is available on the servers. Mobile devices can include any portable intelligent device including, for example, phones, tablets, laptops, smart watches. If the environmental label has not yet been entered into the system with a rating stored on the servers 3, information about the label may stored on the servers 3 and the system may initiate a search as depicted in FIG. 4 to obtain the criteria for the label from the website of the organization that issued the criteria. If the label and criteria information is documented on the server 3 but the expert rating is still in progress, the system may notify the users that a rating is pending. New labels and criteria information 2(a), 2(b), 2(c) may be automatically saved to the servers 3 and sent to teams of experts 4, 5, 6 who will follow the algorithms depicted in FIG. 2 and FIG. 3 to evaluate the criteria provided for an environmental label, compare it with international standards, and store their evaluations of the criteria on the system's servers 3. The system may then calculate a final score for a product based on the information on its environmental labels and the expert scoring of the environmental label criteria. The final score and related information is stored on the server and can be retrieved by users who scan. labels with their mobile devices 1(a), 1(b), 1(c).

FIGS. 2 and 3 show the Expert System's Rating Process Flow. This rating process involves multiple steps that initially begin with a group of environmental experts performing a detailed evaluation of the ISO 14020 standard. This group will look at each of the labeling types; Type I—environmental labeling (i.e. ecolabels), Type II self-declarations claims, and Type III—environmental declarations (e.g. report cards/information labels) and based on their expertise create an Evaluation Criteria Template consisting of no more than 12 sections. Within each section will be additional measures within a section that are used to determine if a rating group's criterion is valid.

Once the Evaluation Criteria Template is completed the actual process of performing an evaluation of a rating group's criteria can be started. This process consists of the following stages:

Based upon the product or service environmental ecolabel and/or certificate the issuer's rating group website is accessed. A search is performed to locate the associated certification criteria documents. If the documents are available these are than downloaded and made available to the Criteria Team. If the documents cannot be located the issuing organization is contacted and a request is made for a copy of the documents. If the issuing organization provides the documents than these are made available to the Criteria Team, if the documents are not provided than this is documented along with any supporting documents into the EcoCaliber Expert System (ECRS) and the next product or service issuer's criteria. documents are search for.

The Criteria Team Manager than selects 3 or more Criteria Evaluation Team members who will work independently during the evaluation process. These individuals will then perform a detailed review of the issuer's criteria and extract relevant sections and association them within the Evaluation. Criteria Template. This process will continue until each applicable section has been completed by all of the team members before the template moves on to the Scoring Team. If any team member identifies a problem the problem is discussed with a Resolution Manager who resolves the issue so that the evaluation can continue.

Once the Scoring Team Manager is notified that the Criteria Evaluation Team has completed their work the Scoring Team Manager selects 3 or more Scoring Team members who cannot be part of the Criteria Team who did the evaluation. Each member scores the template independently and secretly as they do this the relative importance of the criteria sections are weighted in ECRS. Starting with the first Section, the score is entered before proceeding to the next section. Once each section has been scored the final score is calculated by ECRS and is the weighted mean of all the scores. Once the scoring has completed the QA/QC Team Manager is notified. If any of the team members encounters or identifies a problem the Resolution Manager resolves the issue and the Evaluation Criteria Template is returned to the Criteria Team for reevaluation and the process starts again.

When the QA/QC Team Manager receives notification that the scoring is completed the QA/AC Team members are selected consisting of 3 or more members. The team members perform a though check of the Evaluation Criteria Template and results. During this result checking process if any problems or issues are identified the Resolution Manager is notified and resolves the issue if it cannot he resolved the template is returned to the Criteria Team and the process begins again. If there are no problems and the QA/QC Team members pass the Evaluation Criteria Template and Score the Expert Review Manager is notified.

Based on the product or service being rated the Expert Review Manager will select the Review Experts who will participate in the final review process. Based upon their expertise this group will review the Evaluation Criteria Template, any associated documents, scoring, and any notes or comments. Once the review is completed they will approve or reject the final score calculated by the ECRS system. If the Experts Approve the results/score the ECRS system is update and all associated documents will be archived in the ECRS system. If there are any problems these are identified and the Resolution Manager is notified. Based upon the comments/remarks from the Expert Review group the Evaluation Criteria Template is return for reevaluation and the process starts again.

This multistage process is designed to provide an impartial, expert review of the various rating group criteria against an international standard which is constant and applicable across all products and services. Using this as its base and then applying weighted mathematical algorithms to each of the sections the final score/rating will be an accurate reflection of the product or services environmental impact.

Based on this score the consumer can then determine, given similar products or services, which one to purchase no matter what ecolabel or certificate is put there by the company.

In one embodiment, users may automatically search the system to locate information about an environmental label and if no rating is available, automatically request an expert review of the environmental label and begin the process by prompting a search engine to search the internet for the issuing organization and the label's criteria. FIG. 4 provides a graphical overview of the primary architectural components of a client-server database supporting similarity-based indexing, search and retrieval using multiple search engines (Google, Yahoo and Bing, for example) and, for example, sql database queries. Referring to FIG. 4, a client 230(1), 230(2) to 230(m) may be a laptop, intelligent mobile device, pad or other personal intelligent device equipped, for example, with near field communication and by WiFi or wireless telecommunications link to a search manager 220 and servers 200 which may be cloud-based servers. The database (or preferably a collection of databases) 200 utilizes a local client-cloud server architecture that provides simultaneous services to multiple clients, networks of clients and multiple users (such as a household of users) of those clients. Architectures have been implemented that leverage the advantages of parallel computation, using both clusters of computer nodes and single nodes with multiple processors and cores. A commercial off-the-shelf (COTS) database 200 or a computer or network file system (referred. to herein as a “COTS Database”) can be utilized for persistent storage, while the high-performance in-memory indexing and search technologies are implemented in Search Engines 210(1) to 210(n) that operate as cooperating threads or tasks within the overall architecture (for example, searching for competitor data for a given product, jurisdictional sales tax data, service, product provider or service provider data from one or more cloud-based servers supporting the client networks). A Search Manager 220 provides coordination between the Clients 230(1) to 230(m), a COTS Database 200, and Search Engines 210(1) to 210(n), as well as the initial connection protocol for the Clients 230(1) to 230(m). The application can be parallelized by allocating separate computational resources to each component, such as a Search Engine 210(1) to 210(n), by allocating multiple computational resources to any component, as occurs in a Search Engine 210 that utilizes multiple threads, or using a combination of these methods. Communications among components in a parallel implementation may be effected using a communications medium such as a computer network or using shared memory. The NFC communication is short distance between tag or transaction terminal and NFC client but an intelligent telephone client 230 may communicate with a COTS database 200 and search manager 220 that are cloud-based and that database 200 and search manager 220 in turn refer to a search engine 210(1) to 210(n) to collect to data applicable to an environmental label.

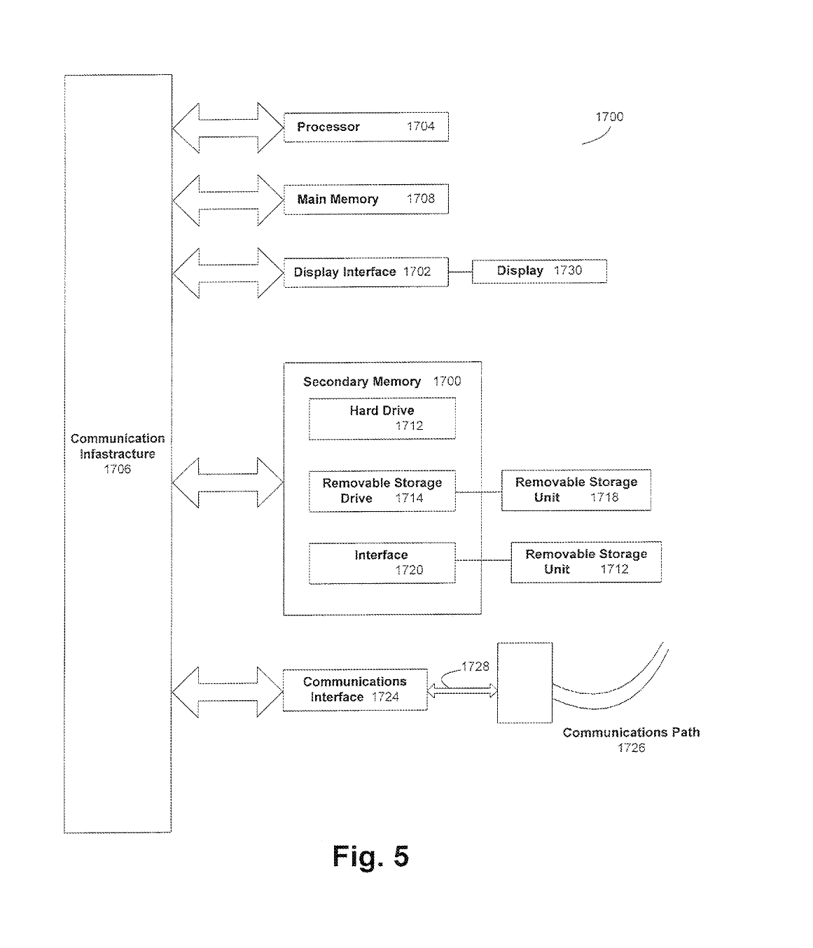

In another embodiment, the invention is directed toward one or more computer systems such as mobile devices capable of carrying out the functionality described herein having associated memory and databases. An example of a computer system 1700 of a sophisticated intelligent mobile device is shown in FIG. 5. The example does not show all aspects of a mobile device such as the camera, a clock, a time of day and date calendar, a GPS unit, an accelerometer and other features of a typical mobile device. However, such features of an ever improving digital camera are typically found in mobile devices known in the art and even comprise video cameras for capturing sequences of images if selected by a user.

Computer system 1700 includes one or more processors, such as processor 1704. The processor 1700 is programmed as a special purpose processor to authenticate a user using biometric (for example, facial structure) and a personal identification code entered by the user each time a mobile device is turned on and prepared for use by an individual user. The processor 1704 is connected to a communication infrastructure 1706 (e.g., a communications bus or network). Various software aspects are described in terms of this exemplary computer system. After reading this description, it will become apparent to a person skilled in the relevant art(s) how to implement the invention using other computer systems and/or architectures.

Users of mobile devices (not shown) communicate with computer system 1700 by means of communications interface 1706, typically a touchscreen having a reprogrammable display or other interface known in the art. A typical mobile device computer used by a user may have a similar structure to computer system 1700, the difference being that computer system 1700 may comprise databases and memory. A mobile device, on the other hand, provides a user with access to any of these for creating new images or doing any of the creation of the images and image portions such as face, eye region and pupil as discussed above.

Computer system 1700 can include a display interface 1702 that forwards graphics, text and other data from the communication infrastructure 1706 for display on the display unit 1730. A display, as will be described herein, may provide a touch screen for, for example, entering data.

Computer system 1700 also includes a main memory 1708 for maintaining the authentication and image processing algorithms described above, preferably random access memory (RAM) for temporary data storage and may also include a secondary memory 1710. The secondary memory 1710 may or may not include, for example, a hard disk drive 1712 and/or a removable storage drive 1714, representing a floppy disk drive, a magnetic tape drive, an optical disk drive, etc. The removable storage drive 1714 reads from and/or writes to a removable storage unit 1718 in a well known manner. Removable storage unit 1718 represents a floppy disk, magnetic tape, optical disk, micro SD card, etc. which is read by and written to by removable storage drive 1714. As will be appreciated, the removable storage unit 1718 includes a computer usable storage medium having stored therein computer software and/or data.

In alternative aspects, secondary memory 1710 may include other similar devices for allowing computer programs or other code or instructions to be loaded into computer system 1700 (for example, downloaded upon user selection from a server). Such memory devices may include, for example, a removable storage unit 1722 and an interface 1720. Examples of such may include a program cartridge and cartridge interface (such as that found in some video game devices), a removable memory chip (such as an erasable programmable read only memory (EPROM), or programmable read only memory (PROM)) and associated socket and other removable storage units 1722 and interfaces 1720, which allow software and data to be transferred from the removable storage unit 1722 to computer system 1700.

Computer system 170 also includes a communications interface 1724 which may be a cellular radio transceiver known in the cellular arts. Mobile communications interface 1724 allows software and data to be transferred between computer system 1700 and external devices and may comprise access to telecommunications, texting, the internet, social networks, movies via NetFlix, games and the like but only after authentication. As discussed above, a biometric and personal identification code multi-factor gaze authentication is presented for use with obtaining access to such device features. Examples of communications interface 1724 may include a modern, a network interface (such as an Ethernet card), an RF communications port, a Personal Computer Memory Card International Association (PCMCIA) slot and card, etc. Software and data transferred via communications interface. 1724 are in the form of non-transitory signals 1728 which may be electronic, electromagnetic, optical or other signals capable of being received by communications interface 1724. These signals 1728 are provided to communications interface 1724 via a telecommunications path (e.g., channel) 1726. This channel 1726 carries signals 1728 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 1714, a hard disk installed in hard disk drive 1712 and signals 1728. Not all intelligent mobile devices have all these features. These computer program products provide software to computer system 1700. The invention is directed to computer authentication methods and apparatus.

Computer programs (also referred to as computer control logic) are typically stored in main memory 1708 and/or secondary memory 1710. Computer programs may also be received via communications interface 1724. Such computer programs, when executed, enable the computer system 1700 to perform_{—} the features of the present invention, as discussed herein. In particular, the authentication computer programs of the present invention, when executed, enable the processor 1704 to perform the features of the present invention and provide access to further features that are virtually unlimited (but importantly, personal to a user individual and should not be accessed by others without permission from the user). Accordingly, such computer programs represent controllers of the computer system 1700.

In an embodiment where the invention is implemented using software, the software may be stored in a computer program product and loaded into computer system 1700 using removable storage drive 1714, hard drive 1712 or communications interface 1724. The control logic (software), when executed by the processor 1704, causes the processor 1704 to perform the functions of the invention as described herein. The present authentication method and apparatus may be downloadable to a mobile device from an applications store.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

As will be apparent to one skilled in the relevant art(s) after reading the description herein, the computer architecture shown in FIG. 17 may be configured as any number of computing devices such as a system manager, a work station, a game console, a portable media player, a desktop, a laptop, a server, a tablet computer, a PDA, a mobile computer, a smart telephone, a mobile telephone, an intelligent communications device or the like.

While various aspects of the present invention have been described above, it should be understood that they have been presented by way of example and not limitation. It will be apparent to persons skilled in the relevant art(s) that various changes in form and detail can be made therein without departing from the spirit and scope of the present invention. Thus, the present invention should not be limited by any of the above described exemplary aspects, but should be defined only in accordance with the following claims and their equivalents.

What I claim is:

1. An expert system for rating credence goods' claims comprising a special purpose processor and data input means for receiving credence goods' expert data from a plurality of independent experts according to one of a national and an international standard for evaluating a particular credence good,
the special purpose processor for receiving particular credence good expert data from the data input means, the data input means receiving expert data of an independent expert independent of another of the plurality of experts for a particular credence good label, the special purpose processor for evaluating the received expert data for the particular credence good label from the input means, evaluating the received expert data according to the one of the national and international standard and storing the evaluation in special purpose processor memory,
the special purpose processor upon receiving a quorum of expert data from a plurality of independent experts having data input means, the quorum being equal to or less than the plurality of independent experts but being greater than one expert of the plurality of independent experts, determining a rating for the particular credence good according to one of national and international standard, and
upon query by an intelligent device of a consumer for the rating of the particular credence good determined by the special purpose processor, outputting the rating to the consumer.

2. An intelligent device for running a special purpose consumer application software program for receiving scanned input data of a label of a particular credence good, the intelligent device for storing the scanned label input data,
the intelligent device further comprising communications interface means for communicating the scanned input label data of the particular credence good to a remote special purpose processor by way of the communications interface means, the remote special purpose processor for outputting an expert rating of the scanned input label of the particular credence good responsive to the receipt of the scanned input label of the particular credence good if an expert rating for the particular credence good is available in memory via the communications interface means to the intelligent device.
